(19) United States
(12) Patent Application Publication
(10) Pub. No.: US 2006/0125924 A1
(43) Pub. Date: Jun. 15, 2006

(54) Range finding digital camera

(75) Inventors: Lin Ing-Song, Taichung (TW); Chang Mei-Pin, Taichung (TW)

Correspondence Address: TROXELL LAW OFFICE PLLC;SUITE 1404, 5205 LEESBURG PIKE, FALLS CHURCH, VA, 22041, US

(73) Assignee: Asia Optical Co., Inc.

(21) Appl. No.: 11/154,806

(22) Filed: Jun. 17, 2005

(30) Foreign Application Priority Data
Dec. 15, 2004 (TW) 093138973

(51) Int. Cl. H04N 5/225; H04N 9/04

(52) U.S. Cl. 348/207.99

(57) ABSTRACT

A range finding digital camera (100) includes a main digital camera and a laser range finder (18) assembled to the main digital camera via a serial or a parallel connection interface. The main digital camera includes an image display (13) and a controller (15) for inputting commands to the laser range finder. The laser range finder includes an optical transmitter (181) for transmitting a transmission laser beam and an optical receiver (182) for receiving a reflection laser beam. The laser range finder is used for measuring the distance between an object and the range finding digital camera in accordance with the time-lag between the transmission time of the transmission laser beam and the receiving time of the reflection laser beam. The measuring result can be displayed on the image display and provided for the digital camera to focus or to calculate a practical dimension of the object.

### BACKGROUND OF THE INVENTION

1. Field of the Invention

The present invention relates generally to a digital camera, and more particularly to a range finding digital camera.

2. Description of the Prior Art

For most digital cameras, automatic focusing (AF) is an indispensable function, though some ones also have manual focus function. One automatic focusing method of a digital camera is to use a charge coupled device automatic focusing (CCD-AF) system which drives a focus lens to move along an optical axis so as to change a focus position from an infinite distance to the closest distance, and finally finds a right focus position. Consequently, the CCD-AF system has high focusing accuracy. However, there is a problem that the system need to spend time detect the positions of multiple focus points while taking a picture, thereby increasing a time-lag between a shutter button being clicked and released. Therefore, it's essential to improve the CCD-AF system in order to reduce the time-lag.

Another automatic focusing method is to use a range finding sensor to directly obtain distance information, and calculate the object distance based on the distance information, so as to speed up focusing and reduce the time-lag. Such a method and the relative digital camera can refer to U.S. Patent Application Publication No. 20040169766. The digital camera as disclosed by the '776 publication comprises an image processing integral circuit (IC), a range finding sensor, a charge coupled device (CCD), a focus lens, and a central processing unit (CPU). These components form a CCD-AF system for obtaining a focus position by sampling a contrast of an object image formed on a light receiving surface with moving a focus lens along an optical axis, and a range finding sensor focusing system for obtaining the focus position by measuring the distance to an object based on a triangular surveying system. However, the range finding sensor focusing system is merely for auxiliary focusing. Once the range finding sensor measures the object distance, it immediately sends the distance information to the image processing IC which communicates with the CPU for finally controlling the focus lens to focus. Though the digital camera can obtain distance information, the accurate level of the range finding is not enough to meet high accuracy requirement and the result of the range finding cannot adequately utilized by the user.

Currently, a range finding digital camera equipped with a range finder has been commercially available. This conventional camera has a pair of refraction mirrors by which the light from the object is reflected to form two focusing images. When rotating a focusing ring of the camera (tuning the focus of the lens), the movement of the focusing ring will drive the refraction mirrors to move via the range finder. When the refraction mirrors are respectively turned to a certain angle, the two focusing images of the object will overlap each other, thereby accomplishing focusing. Related patents can refer to JP Patent Application Laid-open No. 2002-303917 and JP Patent Application Laid-open No. 2003-295260. However, the user's eyes observe whether the two focusing images are overlapped, which inevitably brings observation error. Therefore, both the distance information and the auxiliary focusing are not accurate. Furthermore, each conventional range finding digital camera displays a viewing frame on a liquid crystal display (LCD) in accordance with the lens when focusing. When the lens is exchanged, the viewing frame also needs to be changed in order to suit for different lenses, such as a wide-angle lens or a long-focus lens, which brings inconvenience and trouble to the users.

Besides, as well known, in building measuring fields, there is high requirement of the parameters of a construction, such as distance, dimension and the like. However, in today's market, there is still no simple apparatus for simultaneously shooting a construction and accurately recording the distance and dimension information of the construction, so as to meet the high requirements in these fields.

Hence, a range finding digital camera is required to overcome the above-mentioned disadvantages of the prior art.

### BRIEF SUMMARY OF THE INVENTION

One objective, therefore, of the present invention is to provide a range finding digital camera having a precisely range finding function by which the camera can obtain distance information between an object and the camera itself and accurately calculate the practical distance between the object and the range finding digital camera in terms of the distance information.

Another objective of the present invention is to provide a range finding digital camera having an auxiliary focusing function by which the camera can accurately focus in terms of the distance information.

A further objective of the present invention is to provide a range finding digital camera in which shooting and range finding can be either simultaneously operated or respectively operated.

In order to achieve the above objectives and overcome the above-identified deficiencies in the prior art, the range finding digital camera in accordance with the present invention has a shooting function for shooting an object and a range finding function for obtaining distance information. The range finding digital camera comprises a laser range finder for transmitting and receiving laser beams, and measuring the object distance between the object and the range finding digital camera; a sensor unit for imaging the object thereon; a signal processor for receiving and processing electrical signals from the laser range finder and the sensor unit, and sending back a processing result to the laser range finder and the sensor unit; a display for displaying the processing result of the signal processor which includes the object image and the distance information; and a controller for inputing commands and sending the commands to the laser range finder via the signal processor.

The range finding digital camera has at least a range finding mode, a laser auxiliary focusing mode and a range finding and shooting mode, each being chosen by the controller. Once the range finding mode is chosen, pressing the shutter button leads the range finding digital camera to measure the object distance and show the distance information on the display. Once the laser auxiliary focusing mode is chosen, half pressing the shutter button leads the laser range finder to measure the object distance, and further completely pressing the shutter button leads the range finding digital camera to auxiliarily focus and shoot according to the distance information, so as to merge the distance information with the image file. Once the range finding and shooting mode is chosen, half pressing the shutter button leads the laser range finder to measure the object distance, and further completely pressing the shutter button leads the range finding digital camera to shoot, so as to merge the distance information with the image file finally.

Other objectives, advantages and novel features of the invention will become more apparent from the following detailed description of a preferred embodiment when taken in conjunction with the accompanying drawings.

### BRIEF DESCRIPTION OF THE DRAWINGS

The present invention may best be understood through the following description with reference to the accompanying drawings, in which:

FIG. 1 is a schematic view showing the general structure of a range finding digital camera in accordance with the present invention;

FIG. 2 is a schematic view from another aspect of FIG. 1; and

FIG. 3 is a schematic view illustrating the working theory of the range finding digital camera in accordance with the present invention.

### DETAILED DESCRIPTION OF THE INVENTION

Reference will now be made in detail to a preferred embodiment of the present invention.

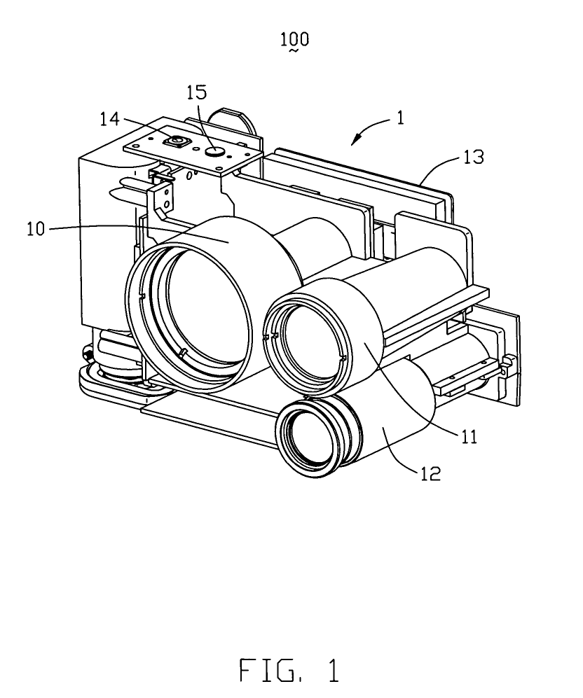

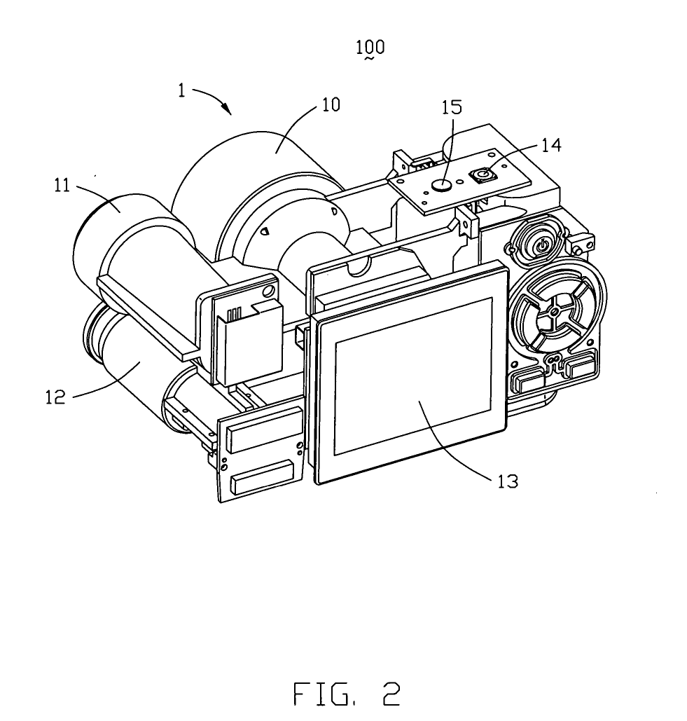

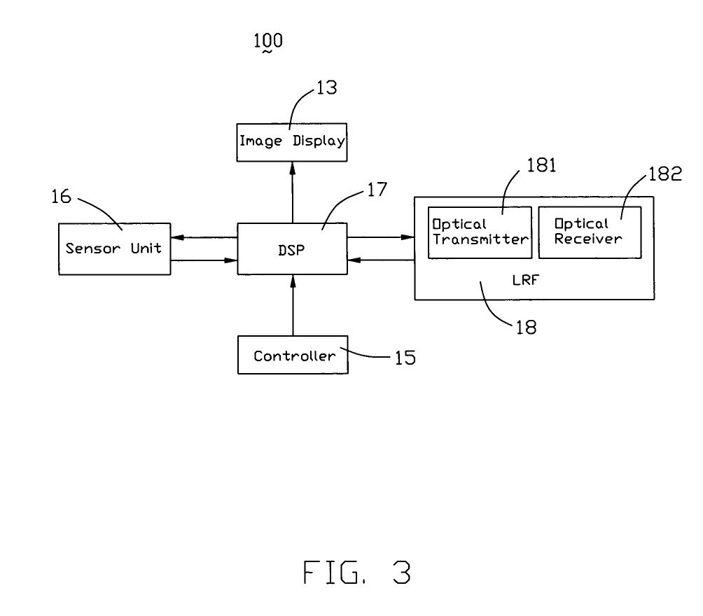

The range finding digital camera in accordance with the present invention combines digital camera technology with laser range finding technology. Referring to FIGS. 1-2, a general structure of the range finding digital camera 100 in accordance with the present invention is shown in different aspects. The range finding digital camera 100 mainly comprises a camera housing 1 assembled with a lens 10, a transmitting sleeve 11, a receiving sleeve 12, an image display 13 (such as a liquid crystal display, LCD), a shutter button 14, a controller 15 and a sensor unit 16 (shown in FIG. 3). The lens 10 is used for picking light come into the camera under the control of the shutter button 14 and imaging an object image on the sensor unit 16. The controller 15 can be a function button or a mode dial and the like for controlling different operation modes (described below in detail) of the range finding digital camera 100. The sensor unit 16 is usually a charge coupled device (CCD), and is used for receiving optical signals having different intensities from the lens 10 and transforming the optical signals into voltage signals. The voltage signals are then processed and passed to the image display 13 for displaying.

Jointly referring to FIG. 3, the range finding digital camera 100 further comprises a digital signal processor (DSP) 17 for making every part, such as the image display 13, the controller 15 and the sensor unit 16 work in phase, and for central data processing, and a laser range finder (LRF) 18 assembled to the camera housing 1 via a serial or a parallel connection interface (not shown) for range finding. The LRF 18 comprises an optical transmitter 181 for transmitting a transmission laser beam to the object through the transmitting sleeve 11, and an optical receiver 182 for receiving a reflection laser beam reflected back by the object through the receiving sleeve 12. The LRF 18 measures an object distance between the object and the range finding digital camera 100 and obtains the distance information (at least including the value of the object distance) by calculating the flight time between transmitting laser beams and receiving the reflection laser beams. For example, the object distance between the object and the range finding digital camera 100 is designated “S”, the speed of the laser beams between transmitting and receiving is designated “v”, and the flight time of the laser beams between transmitting and receiving is designated “t”. Therefore, S=½ (v*t). After processed by a processing circuit (not shown) in the DSP 17, the distance information can help the range finding digital camera 100 for focusing. Meanwhile, the distance information can be displayed on the image display 13, thereby simplifying the design of the LRF 18. Additionally, the distance information can be recorded in an image file which mainly stores the object image and provided for the range finding digital camera 100 to utilize. For example, the range finding digital camera 100 itself can calculate a practical dimension of the object in terms of the value of the distance S and the proportion of the object to the whole picture.

The image display 13, the sensor unit 16, the controller 15 and the LRF 18 are all communicated with the DSP 17. The DSP 17 obtains an inputting command from the controller 15, and receives electrical signals from the sensor unit 16 and the LRF 18. The electrical signals then are processed by the DSP 17. After processing, the processing result is transported to the sensor unit 16, the LRF 18 and the image display 13. On the image display 13, the object image and the distance information can be synchronously or asynchronous displayed.

In application, an adjusting step for adjusting axes of the LRF 18 is necessary before use. The adjusting step comprises: (a) assembling the lens 10 on the camera housing 1; (b) aligning an optical axis of the transmission laser beam with an optical axis of the lens 10; and (c) aligning an optical axis of the reflection laser beam with that of the transmission laser beam.

In conclusion, the range finding digital camera 100 in accordance with the present invention comprises a main digital camera which has a routine shooting function, and an accessional LRF 18 which has a range finding function. The shooting function and the range finding function of the range finding digital camera 100 are reasonable designed in the preferred embodiment of the present invention to be either simultaneously operated or respectively operated by switching the operation modes of the range finding digital camera 100 via the controller 15. The range finding digital camera 100 adds at least three operation modes relating with the accessional LRF 18 besides the customary operation modes relating with the main digital camera. The three operation modes are respectively range finding mode, laser auxiliary focusing mode, and range finding and shooting mode.

If the range finding mode is desired, the following steps should be taken. Firstly, choose the range finding mode in the operation modes via the controller 15. Secondly, a reticle appears on the image display 13 for aiming at the object. Thirdly, press the shutter button 14 for range finding (measuring the object distance) and obtaining a measuring result (the distance information). Fourthly, display the distance information on the image display 13.

If the laser auxiliary focusing mode is desired, the following steps should be taken. Firstly, choose the laser auxiliary focusing mode in the operation modes by the controller 15. Secondly, a reticle appears on the image display 13 for aiming at the object. Thirdly, half press the shutter button 14 for range finding (measuring the object distance) or perform the range finding function at intervals by the LRF 18 itself and obtaining a measuring result (the distance information). Fourthly, display the distance information on the image display 13, wherein the distance information is used to help the camera to quickly calculate the shutter speed and the aperture size, thereby saving the focusing time. Fifthly, completely press the shutter button 14 to auxiliarily focus in terms of the distance information and shoot the object to obtain an object image. Sixthly, save the distance information together with the object image in a corresponding image file.

If the range finding and shooting mode is desired, the following steps should be taken. Firstly, choose the range finding and shooting mode in the operation modes via the controller 15. Secondly, a reticle appears on the image display 13 for aiming at the object. Thirdly, half press the shutter button 14 for range finding (measuring the object distance) and obtaining a measuring result (the distance information). Fourthly, display the distance information on the image display 13. Fifthly, completely press the shutter button 14 for shooting the object and obtaining an object image and meanwhile the LRF 18 sends the distance information to the DSP 17. Sixthly, save the distance information together with the object image in a corresponding image file.

The range finding digital camera 100 in accordance with the present invention adopts a laser range finding technology for accurately range finding and displaying the range finding result on the image display 13 and/or saving the range finding result in the image file, and also for quickly focusing in terms of the range finding result, thereby saving the focusing time and obtaining high quality object images.

It is to be understood, however, that even though numerous characteristics and advantages of the present invention have been set forth in the foregoing description, together with details of the structure and function of the invention, the disclosure is illustrative only, and changes may be made in detail, especially in matters of material, plating method and manufacturing process within the principles of the invention to the full extent indicated by the broad general meaning of the terms in which the appended claims are expressed.

What is claimed is:

1. A range finding digital camera comprising:
a main digital camera comprising a display and a controller for inputting commands; and
a laser range finder assembled to the main digital camera via a connection interface, the laser range finder comprising an optical transmitter for transmitting a transmission laser beam and an optical receiver for receiving a reflection laser beam, the laser range finder measuring an object distance between the range finding digital camera and an under measured object and obtaining the distance information in accordance with the flight time between the transmission time of the transmission laser beam and the receiving time of the reflection laser beam;
wherein, the commands are sent to the laser range finder via the connection interface, and the distance information is sent to the main digital camera via the connection interface for displaying on the display.

2. The range finding digital camera as claimed in claim 1, wherein the connection interface is a serial interface or a parallel interface.

3. The range finding digital camera as claimed in claim 1, having at least a range finding mode, a laser auxiliary focusing mode and/or a range finding and shooting mode, each of these modes being chosen by the controller.

4. The range finding digital camera as claimed in claim 3, wherein the main digital camera comprises a shutter button for being pressed to drive the range finding digital camera to measure the object distance once the range finding mode being chosen.

5. The range finding digital camera as claimed in claim 4, wherein the main digital camera comprises a shutter button for being half pressed to drive the range finding digital camera to measure the object distance once the laser auxiliary focusing mode being chosen, and further for being completely pressed to drive the digital camera to focus in terms of the distance information.

6. The range finding digital camera as claimed in claim 5, wherein the main digital camera comprises a shutter button for being half pressed to drive the range finding digital camera to measure the object distance once the range finding and shooting mode is chosen, and further for being completely pressed to drive the range finding digital camera to shoot for obtaining an object image.

7. The range finding digital camera as claimed in claim 6, wherein the display is used for displaying the object image and the distance information simultaneously or asynchronously.

8. The range finding digital camera as claimed in claim 7, wherein the distance information and the object image are saved in a common file or in separate files.

9. A range finding digital camera comprising:
a laser range finder for transmitting and receiving laser beams, and for measuring an object distance between an object and the range finding digital camera by means of the transmitting and receiving laser beams;
a sensor unit for imaging the object thereon;
a signal processor for receiving and processing electrical signals from the laser range finder and the sensor unit, and sending back a processing result to the laser range finder and the sensor unit;
a controller for controlling the laser range finder via the signal processor; and
a display for displaying the processing result of the signal processor and the distance information obtained by the laser range finder.

10. The range finding digital camera as claimed in claim 9, further comprising a camera housing, and wherein the laser range finder is assembled to the camera housing.

11. The range finding digital camera as claimed in claim 10, wherein the laser range finder comprises an optical transmitter for transmitting a transmission laser beam to the object and an optical receiver for receiving a reflection laser beam reflected back by the object.

12. The range finding digital camera as claimed in claim 11, further comprising a transmitting sleeve and a receiving sleeve assembled to the camera housing, wherein the transmitting sleeve is corresponding to the transmission laser beam, and the receiving sleeve is corresponding to the reflection laser beam.

13. The range finding digital camera as claimed in claim 12, further comprising a lens assembled to the camera housing, wherein the lens has an optical axis, the optical axis of the lens being aligned with that of the transmission laser beam, and the optical axis of the transmission laser beam being aligned with that of the reflection laser beam.

14. The range finding digital camera as claimed in claim 9, having at least a range finding mode chosen by the controller, wherein at this mode, when a shutter button of the range finding digital camera is pressed, the laser range finder starts to measure the object distance.

15. The range finding digital camera as claimed in claim 9, having at least a laser auxiliary focusing mode chosen by the controller, wherein at this mode, when a shutter button of the range finding digital camera is half pressed, the laser range finder starts to measure the object distance, and when the shutter button is completely pressed, the range finding digital camera starts to focus and shoot.

16. The range finding digital camera as claimed in claim 9, wherein the range finding digital camera has at least a range finding and shooting mode chosen by the controller; at this mode, when a shutter button of the range finding digital camera is half pressed, the laser range finder starts to measure the object distance, and when the shutter button is completely pressed, the range finding digital camera starts to shoot.

17. A digital camera combining a laser range finder therewith for transmitting and receiving laser beams and measuring an object distance between an object and the digital camera utilizing the laser beams, the digital camera comprising:
a camera housing;
a sensor unit assembled to the camera housing;
a lens assembled to the camera housing for imaging the object on the sensor unit as an object image;
a shutter button disposed on the camera housing;
a display assembled to the camera housing; and
a controller disposed on the camera housing for starting a laser auxiliary focusing mode of the digital camera;
wherein, when the laser auxiliary focusing mode is started and the shutter button is half pressed, the laser range finder begins to measure the object distance and sends the measuring result to the display, the measuring result being displayed together with the object image.

18. The digital camera as claimed in claim 17, wherein when the laser auxiliary focusing mode is started and the shutter button is completely pressed, the digital camera utilizes the measuring result to focus and shoot for obtaining the object image, the measuring result being saved to an image file together with the object image.

19. The digital camera as claimed in claim 18, wherein the laser range finder comprises an optical transmitter for transmitting a transmission laser beam to the object and an optical receiver for receiving a reflection laser beam reflected back by the object, an optical axis of the lens being aligned with that of the transmission laser beam and the optical axis of the transmission laser beam being aligned with that of the reflection laser beam.
